(19) United States
(12) Patent Application Publication
(10) Pub. No.: US 2022/0284365 A1
(43) Pub. Date: Sep. 8, 2022

(54) Errand Services Software Application

(71) Applicant: Gabriel Cotton, Sierra Vista, AZ (US)

(72) Inventor: Gabriel Cotton, Sierra Vista, AZ (US)

(21) Appl. No.: 17/584,490

(22) Filed: Jan. 26, 2022

Related U.S. Application Data
(60) Provisional application No. 63/156,670, filed on Mar. 4, 2021.

(51) Int. Cl. G06Q 10/06; G06Q 50/30; H04L 51/046

(52) U.S. Cl. CPC G06Q 10/06311; G06Q 50/30; H04L 51/046

(57) ABSTRACT

An errand running software application that allows users to subcontract other users to run errands on their behalf. The errand running software application enables the users to create their profile and upload information on what types of errands or tasks need to be completed and allows them to request errands for subcontracting. The errand running software application also features a subcontractor interface which allows subcontractors to sign up on the application, go through a background check, and receive real-time updates on the errand requests. The users and the subcontractors can coordinate with each other on the user interface of the software application as per the desires and availabilities. The invention offers a convenient way to have errands completed by others, and is particularly advantageous for individuals with disability, mobility, and/or capability issues.

### CROSS-REFERENCE TO RELATED APPLICATION

The present application claims priority to, and the benefit of, U.S. Provisional Application No. 63/156,670, which was filed on Mar. 4, 2021 and is incorporated herein by reference in its entirety.

### FIELD OF THE INVENTION

The present invention relates generally to a field of errand services. More specifically, the present invention relates to a software application designed to subcontract errand running (i.e. running of errands). The software application allows users to create a profile and upload their requirements, and subcontract other users to run errands on their behalf. The errand-running software application of the present invention offers an easy method to get user's errands finished by others, thereby saving time throughout the day. Accordingly, this disclosure makes specific reference thereto the present invention. Nonetheless, it is to be appreciated that aspects of the present invention are also equally applicable to other like applications, devices and methods of manufacture.

### BACKGROUND OF THE INVENTION

By way of background, errand service providers and task subcontractors are some of the most prominent and successful businesses. The errand service industry is a business that provides errand services for completing tasks such as mowing a lawn, getting groceries, going to the bank, caring for a pet, cleaning and many more. Nowadays, people are very busy in their lives, and there can be many pending errands that individuals need to attend to daily. People may have trouble obtaining help for running errands, for example, completing tasks like mowing a lawn, getting groceries, caring for a pet, cleaning, etc. Further, people with disabilities or mobility issues may have difficulty in completing their daily tasks or may lack the knowledge or tools to complete their daily tasks like mowing a lawn, getting groceries, caring for a pet, cleaning, etc.

There are well-known errand service-providing systems in the prior art which may help individuals in getting their errands accomplished. The user may contact an agent who receives an order of a customer in a call center. A coordinator at the call center describes the current location of the customer, order information such as the type of service, time, due date and the like. Next, the coordinator uploads the order information to the server, and the server delivers the order contents to the terminal of the performers who carry out the order information. The selected performer directly visits the customer through telephone contact and then performs a service. Next, after the service is completed, a payment step is performed in which the customer pays the attendant. However, there can be problems faced by the customers in the existing errand service-providing systems.

For example, the cost is fixed, and the cost is a vendor-oriented cost, which has disadvantages for the customer. Also, labor costs and service costs are increased due to the requirement and involvement of a plurality of coordinators in the existing errand-providing systems available to customers. Also, with the existing errand systems, the users may not always be able to request an errand near to their location, thereby failing to secure errand services as required. Further, these errand providing services may not be easily accessible to all the individuals. Also, the users requesting an errand service may not be aware of the background check of the performer who visits them for performing the required task. Additionally, in the current systems, once the task is completed, the users may not be able to convey their feedback to the errand-providing systems.

Therefore, there exists a long felt need in the art for an errand service-providing solution that allows users to subcontract other users to run errands on their behalf. There is also a long felt need in the art for an errand-providing service that easily coordinates errands to be finished by others and saves the time of the users. There is also a long felt need in the art for an errand service-providing solution that helps people with disabilities or mobility issues to complete their daily tasks, such as getting groceries, going to the bank, caring for a pet, cleaning and many more. There is also a long felt need in the art for an errand service-providing solution that enables the users to be aware of background checks of the performer of their tasks. Further, there is a long felt need in the art for an errand service-providing solution that is cost-effective and is easily accessible by all individuals. Furthermore, there is a long felt need in the art for an errand service-providing solution that allows the users to convey their feedback for the tasks performed on their behalf. Finally, there is a long felt need for an errand service-providing solution that offers a convenient way for people to get their errands finished by others.

The subject matter disclosed and claimed herein, in one embodiment thereof, comprises a system to subcontract errand running. The system comprises: a computer-implemented software application installed in an electronic device of an errand running subcontracting user, and in the electronic devices of one or more drivers or subcontractors performing the requested errand-running; an application server, wherein the requesting user generates an errand-running subcontracting request; the application server receives the errand-running request and broadcasts the request to nearby drivers or subcontractors which are physically present within a predetermined radius of the user; and a driver or subcontractor accepts the errand-running request and performs the errand-running. The computer-implemented software application provides graphical user interfaces for the user and the subcontractor to sign up for the application, create profiles, request and accept errands and provide ratings and comments for the errand-running task.

In this manner, the novel errand-running software application of the present invention accomplishes all of the forgoing objectives, and provides a relatively easy, convenient, and cost-effective solution for individuals to get their errands finished by others on their behalf and save their time throughout the day, week and month. The errand-running software application is also user-friendly, as it offers an easy way of arranging drivers/subcontractors for completing the tasks of the users, while allowing them to convey their feedback to the drivers/subcontractors and easily issue payments for the completed tasks.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a system to subcontract errand running. The system comprises: a computer-implemented software application installed in an electronic device of an errand-running subcontracting user and in the electronic devices of one or more drivers or subcontractors performing the requested errand-running; an application server, wherein the requesting user generates an errand-running subcontracting request; the application server receives the errand-running request and broadcasts the request to nearby drivers or subcontractors which are physically present within a predetermined radius of the user; and, a driver or subcontractor accepts the errand-running request and performs the errand-running. The computer-implemented software application provides graphical user interfaces for the user and the subcontractor to sign up for the application, create profiles, request and accept errands and provide ratings and comments for the errand-running task.

In yet another embodiment of the present invention, a method for matching drivers/subcontractors with requesting users of errand services is disclosed. The method performed by one or more processors comprises: receiving from an errand-running software application (i.e. app) installed in a requesting user device over one or more networks; an errand service request specifying an errand service; an errand service location; a service time and any additional preferences; identifying a plurality of proximate drivers/subcontractors based on the errand service request location and expertise of the drivers/subcontractors; broadcasting the errand-service request to the errand-running software installed in the computing devices of the identified drivers/subcontractors; receiving an acceptance from a driver/subcontractor to perform the requested errand service; notifying the requested user about the driver/subcontractor; and, sharing the driver/subcontractor details and receiving comments and ratings from the user about the driver/subcontractor upon completion of the requested errand service.

In yet a further embodiment of the present invention, an errand-running software application is disclosed, which allows users to create a profile and subcontract other users to get their errands finished on their behalf. More specifically, the errand-running software application allows users to upload information on the type of errands or tasks that need to be completed. The errand-running software application features a driver/subcontractor interface, which allows drivers/subcontractors to contact customers in which subcontracting has been requested via the application. The errand-running software application allows drivers/subcontractors to sign up with the application, go through a background check and select a user requesting an errand service. The errand-running software application allows users to select a driver/subcontractor and rate and/or comment on a driver/subcontractor profile to ensure tasks are completed to a high standard. Additionally, the software application may be used to provide a notification to all drivers/subcontractors in a geographic area regarding the particulars of an errand task and allows them to select or reject the requested errand task.

According to one aspect of the present invention, an errand subcontracting management system is provided utilizing a “cloud-based” or a remote server, and a portable electronic device that communicates with the server by way of wireless connections. The system allows an errand service to be subcontracted by a user to a driver/subcontractor. The system provides each user or driver/subcontractor with his or her own individual interfaces of an errand-running software application installed in the portable electronic devices. Additionally, the system supports the creation of profiles of both the user and the driver/subcontractor, and enables the connecting of drivers/subcontractors to users to be selected for performing the requested errand services.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic diagram of a system designed to subcontract other users to run errands using one potential embodiment of the errand-running software application of the present invention in accordance with the disclosed architecture;

FIG. 2 illustrates a perspective view of the initial login or sign-up interface shown on the errand-requestor version of the errand-running software application for creating a user profile in accordance with the disclosed architecture;

FIG. 3 illustrates an exemplary graphical user interface of the errand-running software application for requesting one or more errand services by a requesting user in accordance with the disclosed architecture;

FIG. 4 illustrates a flow diagram showing the steps of using the errand-running software application for requesting one or more errand services, which are performed by one or more driver/subcontractors/subcontractors in accordance with the disclosed architecture;

FIG. 5 illustrates an exemplary graphical user interface of an errand-running software application of the requesting user showing selected driver/subcontractor information and errand task status in accordance with the disclosed architecture;

FIG. 6 illustrates a flow diagram showing the steps performed by a driver/subcontractor or performer of an errand request using the errand-running software application installed in a driver/subcontractor mobile device in accordance with the disclosed architecture;

FIG. 7 illustrates an exemplary driver/subcontractor sign-up interface for creating a driver/subcontractor profile in accordance with the disclosed architecture; and

FIG. 8 illustrates an exemplary graphical user interface of an errand-running application for accepting an errand task in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for an errand service-providing solution that allows users to subcontract other users to run errands on their behalf. There is also a long felt need in the art for an errand providing service that easily coordinates errands to be accomplished by others, thereby saving time for the users. There is also a long felt need in the art for an errand service-providing solution that helps people with disabilities or mobility issues to complete their daily tasks such as getting groceries, going to the bank, caring for a pet, cleaning and many more. There is also a long felt need in the art for an errand service-providing solution that enables the users to be aware of background checks of the performer of their tasks. Further, there is a long felt need in the art for an errand service-providing solution that is cost-effective and is easily accessible by all individuals. Furthermore, there is a long felt need in the art for an errand service-providing solution that allows the users to convey their feedback for the tasks performed on their behalf. Finally, there is a long felt need for an errand service-providing solution that offers a convenient way for people to get their errands finished by others.

The subject matter disclosed and claimed herein, in one embodiment thereof, comprises a system to subcontract errand-running. The system comprises: a computer-implemented software application installed in an electronic device of an errand running subcontracting user and in the electronic devices of one or more driver/subcontractors/subcontractors or subcontractors performing the requested errand-running; an application server, wherein the requesting user generates an errand-running subcontracting request; the application server receives the errand-running request and broadcasts the request to nearby driver/subcontractors/subcontractors or subcontractors who are physically present within a predetermined radius of the user; and, a driver/subcontractor or subcontractor accepts the errand-running request and performs the errand-running. The computer-implemented software application provides graphical user interfaces for the user and the subcontractor to sign up for the application, create profiles, request and accept errands and provide ratings and comments for the errand running task.

The subject matter disclosed and claimed herein, in another embodiment thereof, comprises a method of matching subcontractors with requesting users of errand services. The method comprises: receiving an errand service request from a requesting user on an errand-running software app installed in a requesting user device over one or more networks; wherein the errand-service request specifies an errand service, an errand service location and a desired errand-service completion time; identifying a plurality of proximate subcontractors based on the errand service request and the errand service location; broadcasting the errand service request to the identified plurality of the proximate subcontractors; receiving an acceptance from at least one of the identified plurality of the proximate subcontractors to perform the errand-service request; notifying the requesting user of the identified plurality of the proximate subcontractors; sharing the identified plurality of the proximate subcontractors with the requesting user; coordinating the errand-service request with the identified plurality of the proximate subcontractors; and, wherein the coordinating of the errand-service request with the identified plurality of the proximate subcontractors, including selectively accepting or declining at least one of the identified plurality of the proximate subcontractors by the requesting user.

As used herein, an electronic device or a computing device refers to devices comprising desktop computers, cellular devices or smartphones, personal digital assistants (PDAs), laptop computers, tablet devices, television (IP Television), etc., that can provide network connectivity and processing resources for communicating with the system over a network. The computing device can also correspond to custom hardware, in-vehicle devices, or on-board computers, etc. The computing device can also operate a designated application configured to communicate with the on-demand delivery system.

One or more examples described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically-performed step may or may not be automatic.

Furthermore, one or more examples described herein may be implemented through the use of instructions that are executable by one or more processors. These instructions may be carried out on a computer-readable medium. Examples of computer-readable mediums include permanent memory-storage devices, such as hard drives on personal computers or servers. Other examples of computer-storage mediums include portable storage units, such as CD or DVD units, flash memory drives (such as carried on smartphones, multifunctional devices or tablets), and magnetic memory devices. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer-usable carrier medium capable of carrying such a program.

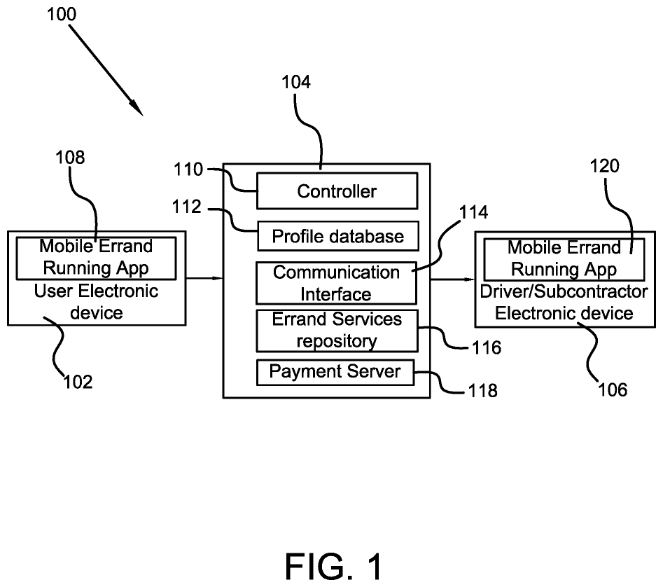

Referring initially to the drawings, FIG. 1 illustrates a schematic diagram of a system to subcontract other users to run errands using an errand running software application of the present invention in accordance with the disclosed architecture. As shown, the errand request-generating system 100 includes one or more user electronic devices 102, an errand services application server 104, and one or more driver/subcontractor electronic devices 106. The present invention provides different interfaces for the users who are requesting/subcontracting the errands, and for the users who are performing the errands. Each of the one or more user electronic devices 102 has installed the errand-running software application 108. The errand-running software application 108 allows a user to create a profile and allows users who are busy, disabled, unable, incapable, or otherwise not able to request an errand service to get their errands performed by others on their behalf. The errand-running software application 108 displays a user interface to the users for requesting errands and automatically sends the user requests for the errand service to the application server 104.

The application server 104 facilitates the broadcasting of the user requests to nearby drivers/subcontractors, or a second set of users; each of them having the errand-running software application with a driver/subcontractor interface 120. The errand-running software application with the driver/subcontractor interface 120 allows the drivers/subcontractors to create a driver's/subcontractor's profile and allows the drivers/subcontractors to contact requesting users, through whom subcontracting services can be coordinated via the errand-running software application 108. It should be appreciated that the errand-running software application 108 for the users and the drivers/subcontractors is essentially the same. However, the interface for the users and the drivers/subcontractors would be customized to allow requests from the users and acceptance of the requests by the drivers/subcontractors.

The errand application server 104 has a controller 110, a profile database 112, a communication interface 114, an errand-services repository 116 and a payment server 118. The controller 110 may handle errand-service requests of the users and forward the user's requests for errand services to the drivers/subcontractors on their version of the errand-running software application 120. The errand application server 104 uses the geographic location of the user requesting errand services and broadcasts the user request to the drivers/subcontractors that are geographically nearby the location of the requesting user.

The profile database 112 may store the users' profile information and the subcontractors' profile information. The profile database 112 may include information which is entered by the users and subcontractors while registering on the errand-running software application user interface 108, 120. The information may include the name, address, errand request preferences, date of birth, age and other similar information about the users. The subcontractors may also need to upload the necessary documents for background verification before becoming eligible to perform errands. The communication interface 114 allows communication with one or more users' electronic devices 102, and with one or more subcontractors' electronic devices 106. The communication interface 114 of the application server 104 is used for automatically sending the notification of an errand task to the subcontractor's errand-running software application 120, installed in the subcontractor's electronic device 106. The errand-services repository 116 has information related to all of the different types of errand services such as mowing a lawn, picking up groceries, going to the bank, caring for pet, walking a dog, cleaning a house, cleaning a car and many more services that are offered on the errand-running software application of the present invention.

The payment server 118 may store information related to a user-preferred payment method such as a debit card, credit card, online payment or other methods of payment. Users may also perform transactions for the completed task(s) using a website provided by the payment server 118. The payment server 118 may be integrated to the application server 104 or the application server 104 may be coupled to a third-party payment server or gateway 118 to process the payment initiated by the users.

It should be appreciated that people who are busy, or have disability/mobility issues, other constraints can create a profile and upload information on what type of errands or tasks need to be completed. The mobile errand-running app 108 provides users with a software application designed to subcontract errand running. It offers a way for individuals to get their errands finished by others, thereby saving them time.

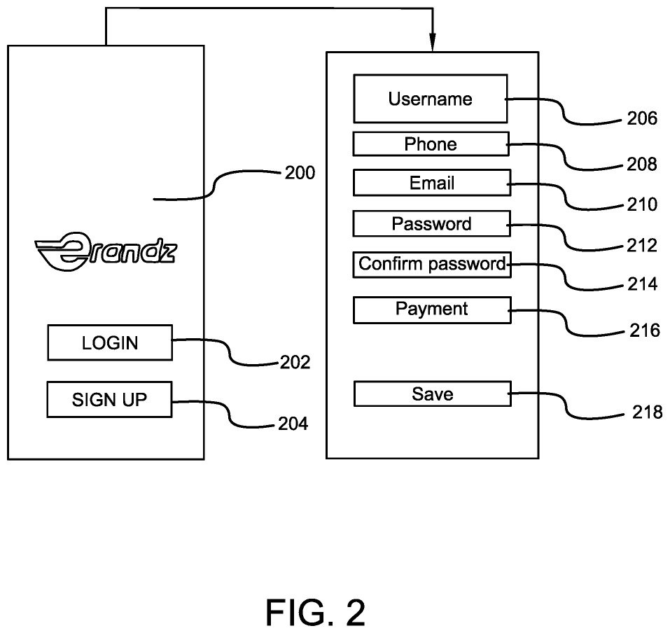

FIG. 2 illustrates a perspective view of an initial login or sign-up interface shown on the errand-requestor version of the errand-running software application for creating a user profile in accordance with the disclosed architecture. A requesting user can create a personal profile using a login or sign-up graphical user interface (GUI) 200. The graphical user interface 200 of the errand-running software application provides a login option 202 for the users who are already registered on the errand running software application, and also provides a sign-up option 204 for the users who are using the application 108 for the first time. The sign-up option 204 requires a user to create a profile by providing information such as a username 206, contact number 208 and email ID 210. The sign-up option 204 requires a user to input a password in a password text box 212, and confirm the password in a confirm password textbox 214 for the secure login. The password 212 and confirming password 214 option may accept either text or alphanumeric values and at least one special case character. The sign-up option 204 may also provide the user with an option to input payment information 216, such as the user's preferred payment method such as a debit card, credit card, online payment or any other preferred method for transmitting payments. Users must establish a unique username 206 and password 212, along with other additional required fields in order to complete the signup process.

Once a user has inputted all the information, the user then hits the “save” button 218 and the data is then sent to the application server. Once the signup 204 process is complete, an email is delivered to the user containing an activation link. Once the account is activated, the user can login 202 to the application by providing login credentials, username 206 and password 212 on the login screen. Thereafter, a graphical user-interface for requesting errand services is displayed to the user. It should be appreciated that, if the user forgets his or her password, the user is prompted to enter the registered email ID, and then a new password can be established by following instructions that are sent to the registered email address.

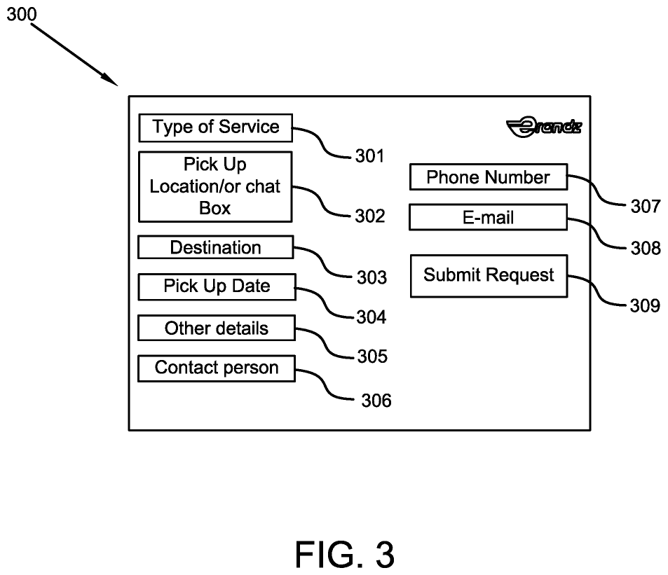

FIG. 3 illustrates an exemplary graphical user-interface of the errand running software application for requesting one or more errand services by a requesting user (i.e. a requestor) in accordance with the disclosed architecture. As shown in FIG. 3, the errand-running software application executing on a user device provides an errand requesting graphical user interface 300 which allows the user to request one or more of errand tasks such as a driver for going to a destination; a subcontractor for completing a task such as mowing a lawn, getting groceries, going to the bank, caring for a pet, walking a dog, cleaning a house or car and many more. The errand-requesting graphical user interface 300 provides a type of service 301 option selection which can provide to the user a chose of a plurality of errand tasks. There can be a drop-down listing of the errand services from which the user can select one or more desired services. The graphical user interface 300 further provides a pick-up location header 302, a destination header 303, a pick-up date header 304, and an option to provide additional details 305 such as user car preference and any other additional desired instructions. The requesting user may also input a contact person 306, a phone number 307 and an email ID 308.

The pick-up location 302 may be manually inputted by the requesting user in the form of an address, or the errand-running software application may determine a pick-up location based on the requesting user's current location using the GPS sensor of the user's electronic device. Once the requesting user inputs all the necessary information, the user then submits the errand request using the submit request header 309, and the user's request for an errand service is then received by the errand application server.

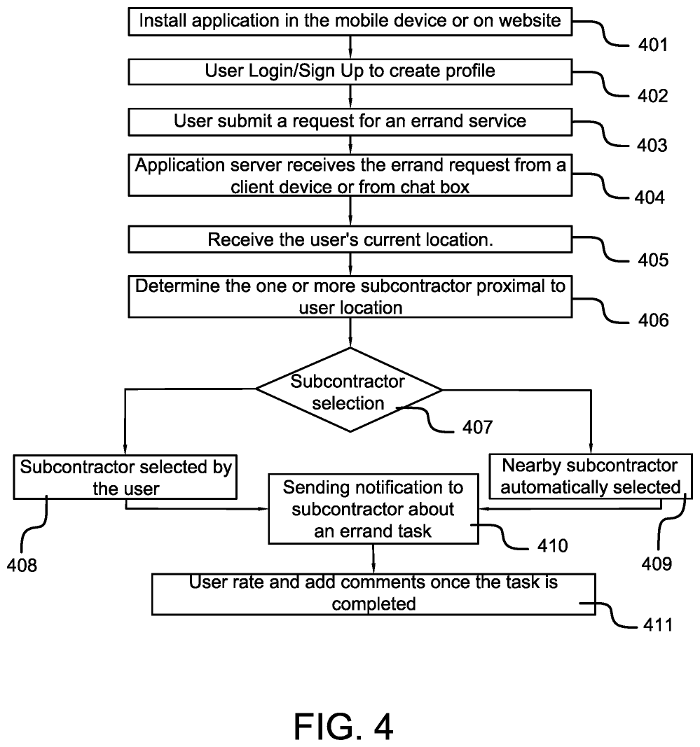

FIG. 4 illustrates a flow diagram showing the steps of using the errand-running software application for requesting one or more errand services which are performed by one or more drivers/subcontractors in accordance with the disclosed architecture. Initially, a requesting user (i.e. requestor) installs the errand-running software application in an electronic device such as a smartphone or on a website (Block 401). The errand-running software application is designed to subcontract errand-running and allows users who are busy, or have disability/mobility constraints, to get their errands finished by others. The user logs-in or signs-up on the application to create a user profile (Block 402). Then, the user submits the request for an errand service, such as for a driver/subcontractor to complete a particular errand(s), to the application server (Block 403). The application server receives the errand request from the user (Block 404) (e.g., via a chat box) and simultaneously receives the user's current geographic location or the geographic location of the errand (Block 405). The application server in real-time determines one or more drivers/subcontractors (errand performers) nearby the user's geographic location (Block 406) and broadcasts the errand request to the drivers/subcontractors in the system. Then, the driver/subcontractor selection is completed for performing the errand request (Block 407). A driver/subcontractor may be selected by the requesting user based on the background check or driver/subcontractor profile (Block 408).

Alternatively, the driver/subcontractor may be automatically selected by the errand application server based on the proximity of the driver/subcontractor to the user location along with the preference matching of the driver/subcontractor and the requested errand service. Thereafter, the application server sends the notification to the driver/subcontractor interface of the errand-running software application of the errand task and associated details (Block 410). Once the requested errand is complete, a notification is shown on the user application and the errand-running software application installed in the user's mobile device can provide the user with an option to rate and add comments regarding the driver/subcontractor to ensure that the tasks are completed with a high standard (Block 411).

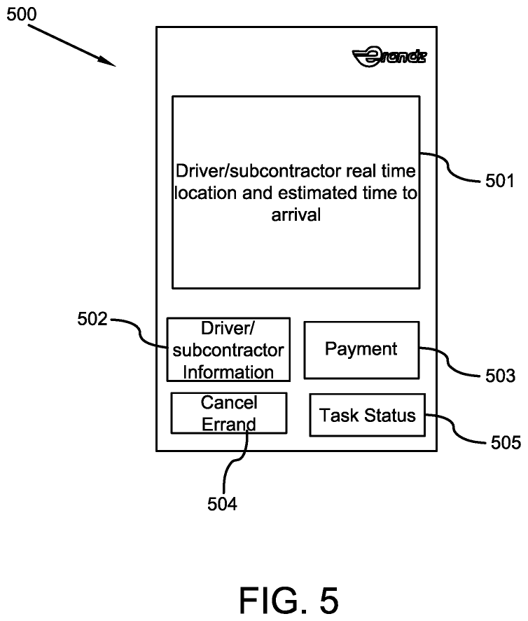

FIG. 5 illustrates an exemplary graphical user interface of the errand-running software application of the requesting user showing selected driver/subcontractor information and errand task status in accordance with the disclosed architecture. The errand-running software application provides the requesting user with a graphical user interface 500 showing the selected driver/subcontractor information. The graphical user interface 500 of the errand-running software application can provide the user with real time driver/subcontractor location and estimated to arrival 501 at the user location. The graphical user interface 500 also provides the user with the driver/subcontractor information 502 such as driver/subcontractor profile, contact number, a background check information or previously received ratings. The graphical user interface 500 also provides a payment option 503 which may have details about the user's preferred payment method such as a debit card, credit card, online payment and many more. The user, by selecting the payment option 503, can complete the transaction for the errand service requested. The graphical user interface 500 provides the user with an option to cancel the requested errand service by choosing the cancel option 504. The user can know the status of the errand request in real-time using the Task status header 505. The task status may be one of “To be initiated”, “Work in Progress (WIP)”, “Cancelled”, “Delayed”, “Completed” or any other relevant status to allow the user to know the real-time status of the errand request.

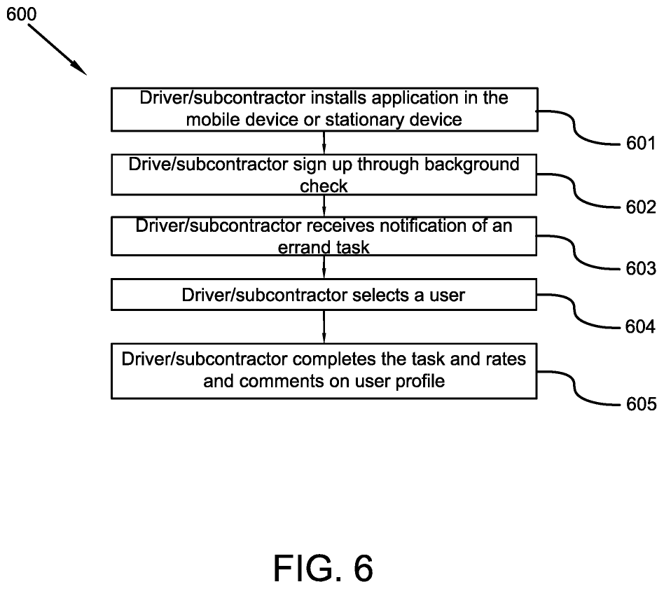

FIG. 6 illustrates a flow diagram showing the steps performed by a driver/subcontractor or performer of an errand request using the errand-running software application installed in a driver/subcontractor mobile or stationary device in accordance with the present invention. As shown in FIG. 6, initially, a driver/subcontractor installs the errand-running software application in the electronic device (Block 601). The driver/subcontractor version of the errand-running software application can allow the driver/subcontractor to select a requested errand task. After installation of the application, the driver/subcontractor logs in or signs up in the application to create a driver/subcontractor profile (Block 602). At the time of sign-up, the driver/subcontractor can be asked to pass a background check process. For the background check, the driver/subcontractor can provide information such as a driver's license number, social security number, age verification document, insurance document for the vehicle and other similar information. Once a user has requested the completion of an errand task on the errand-running software application installed on a user's mobile device, the software application installed on the subcontractor's mobile device receives a notification about the errand task requested by the user (Block 603). The subcontractor can select the user based on the preference, and user information (Block 604). Alternatively, the subcontractor can reject the errand task request as per the desires of the subcontractor. In case the driver/subcontractor accepts the task, the driver/subcontractor either schedules the completion of the errand request or starts working on the errand request. Once the request is completed by the driver/subcontractor, the driver/subcontractor can rate and comment on the user profile, and vice versa (Block 605). The payment is also credited to the account of the driver/subcontractor after the completion of the errand request.

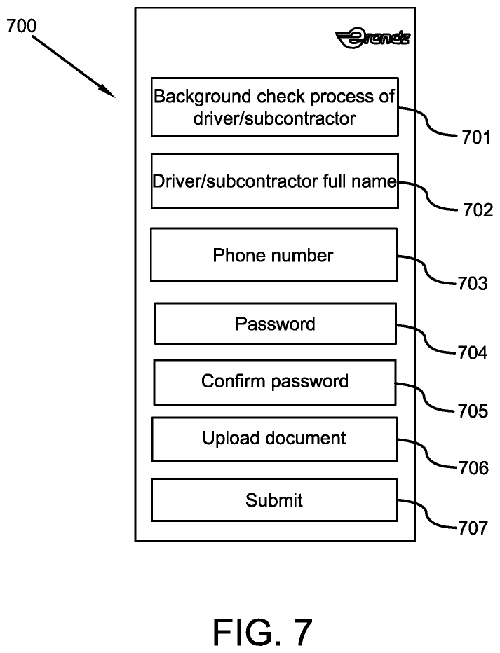

FIG. 7 illustrates an exemplary driver/subcontractor sign-up interface for creating the driver/subcontractor profile in accordance with the disclosed architecture. As shown in FIG. 7, the errand-running application allows a driver/subcontractor to create a driver/subcontractor profile via a graphical user interface (GUI) 700. The graphical user interface 700 enables the driver/subcontractor to upload the necessary documents and perform the background check process 701. The background check process 701 for a driver/subcontractor can provide information such as a driver's license number, social security number, age verification document, insurance document for the vehicle and other similar information. The graphical user interface 700 can ask for the driver/subcontractor to input the driver/subcontractor's full name 702, phone number 703, password 704, and confirmation of the password 705. The password 704 and confirm password 705 options can accept either text or alphanumeric values and at least one special case character.

The graphical user interface 700 can enable the driver/subcontractor to upload documents 706 such as a driver's license, vehicle insurance paper and other types of necessary documents. Once a driver/subcontractor has inputted all the information, the driver/subcontractor submits the information using the submit button 707, and the data is then sent to the application server. Once the driver/subcontractor account is activated, the driver/subcontractor can select a user requesting the errand services.

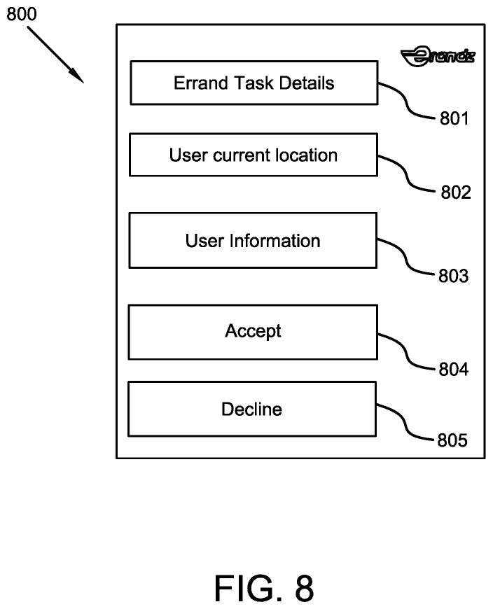

FIG. 8 illustrates an exemplary graphical user interface of the errand-running application for accepting an errand task in accordance with the disclosed architecture. As shown in FIG. 8, the task acceptance graphical user interface 800 provides a driver/subcontractor with the requested errand task or service details 801 requested by a user through the errand-running app installed in a user device. The graphical user interface 800 can also provide the driver/subcontractor with a user's current geographic location or the geographic location of the errand task 802 and user profile information 803. The driver/subcontractor can accept 804 or reject 805 the requested task using the graphical user interface 800. Once a driver/subcontractor who accepts the errand task and performs the errand of the user completes the task, the user can then initiate the payment transaction accordingly. Once the task is completed, the user is provided with an option to rate and comment on subcontractor profiles to ensure tasks are completed to a high standard.

The errand-running software application, according to the embodiment of the present invention, provides users who are busy, or have disabilities or mobility issues, with the advantage to get their errands finished by others on their behalf, saving time throughout the day and may also be web based. The errand-running software application smoothly performs the errand service according to the requirements of the user. Although the technical idea of the errand-running software application as a mobile software application of the present invention has been described above with the accompanying drawings, this is illustrative of the best embodiment of the present invention and is not intended to limit the present invention. The errands may also include, without limitation, dog walking, food delivery, flat tire assistance, courier services, etc.

The errand application server may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the aspects described herein may take the form of a computer program product embodied in one or more computer-readable medium(s) having a computer-readable program code embodied thereon.

Certain terms are used throughout the following description and claims to refer to particular features or components. As one skilled in the art will appreciate, different persons may refer to the same feature or component by different names. This document does not intend to distinguish between components or features that differ in name, but not in structure or function. As used herein “errand-running software application”, “errand-running application”, and “software application” are interchangeable and refer to the errand-running software application 108, 120 of the present invention. Similarly, as used herein “errand request-generating system” and “a system to subcontract errand services” are interchangeable and refer to the errand request-generating system 100 of the present invention.

Notwithstanding the forgoing, the errand request-generating system 100 and the errand-running software application 108, 120 of the present invention can include any additional components to enhance the functionality and efficiency of the errand-running software application 108, 120 and the system 100. One of ordinary skill in the art will appreciate that the configuration and components of the errand-running software application 108, 120, and the system 100, as shown in the FIGS., are for illustrative purposes only, and that many other configurations and components are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A method of matching subcontractors with requesting users of errand services, the method comprising:
receiving an errand service request from a requesting user on an errand running software app installed in a requesting user device over one or more networks;
wherein said errand service request specifying at least an errand service, an errand service location, and a desired errand service completion time;
identifying a plurality of proximate subcontractors based on said errand service request and said errand service location;
broadcasting said errand service request to said identified plurality of said proximate subcontractors;
receiving an acceptance from at least one of said identified plurality of said proximate subcontractors to perform said errand service request;
notifying said requesting user about said at least one of said identified plurality of said proximate subcontractors;
sharing said at least one of said identified plurality of said proximate subcontractors with said requesting user;
coordinating said errand service request with said at least one of said identified plurality of said proximate subcontractors; and
receiving comments and ratings from said requesting user about said at least one of said identified plurality of said proximate subcontractors upon completion of said errand service request.

2. The method of claim 1, wherein said receiving an errand service request from said errand running software app installed in said requesting user device over one or more networks includes information of said requesting user selected from a group consisting of a username, a user telephone number, a user email address, a user password, and a user payment method.

3. The method of claim 1, wherein said receiving an errand service request from said errand running software app includes a text of said errand service request.

4. The method of claim 3, wherein said receiving said errand service request includes selectively accepting or declining said text of said errand service request.

5. The method of claim 1, wherein said coordinating said errand service request with said at least one of said identified plurality of said proximate subcontractors includes selectively accepting or declining said errand service request by said at least one of said identified plurality of said proximate subcontractors.

6. The method of claim 1, wherein said coordinating said errand service request with said at least one of said identified plurality of said proximate subcontractors includes selectively accepting or declining said at least one of said identified plurality of said proximate subcontractors by said requesting user.

7. The method of claim 5, wherein said coordinating said errand service request with said at least one of said identified plurality of said proximate subcontractors includes selectively accepting or declining said at least one of said identified plurality of said proximate subcontractors by said requesting user.

8. The method of claim 7, wherein identifying said plurality of proximate subcontractors based on said errand service and said errand service location includes subjecting said plurality of subcontractors to background checks.

9. The method of claim 8, wherein receiving said acceptance from at least one of said identified plurality of said proximate subcontractors to perform said errand service request includes information of said at least one of said identified plurality of said proximate subcontractors selected from a group consisting of a subcontractor name, a subcontractor telephone number, and a subcontractor password.

10. The method of claim 9, further comprising receiving comments and ratings from said at least one of said identified plurality of said proximate subcontractors about said requesting user upon completion of said errand service request.

11. A method of matching subcontractors with requesting users of errand services, the method comprising:
receiving an errand service request from a requesting user on an errand running software app installed in a requesting user device over one or more networks;
wherein said errand service request specifying at least an errand service, an errand service location, and a desired errand service completion time;
identifying a plurality of proximate subcontractors based on said errand service request and said errand service location;
broadcasting said errand service request to said identified plurality of said proximate subcontractors;
receiving an acceptance from at least one of said identified plurality of said proximate subcontractors to perform said errand service request;
notifying said requesting user about said at least one of said identified plurality of said proximate subcontractors;
sharing said at least one of said identified plurality of said proximate subcontractors with said requesting user;
coordinating said errand service request with said at least one of said identified plurality of said proximate subcontractors; and
wherein said coordinating said errand service request with said at least one of said identified plurality of said proximate subcontractors includes selectively accepting or declining said at least one of said identified plurality of said proximate subcontractors by said requesting user.

12. The method of claim 11, wherein said receiving an errand service request from said errand running software app installed in said requesting user device over one or more networks includes information of said requesting user selected from a group consisting of a username, a user telephone number, a user email address, a user password, and a user payment method.

13. The method of claim 12, wherein said receiving an errand service request from said errand running software app includes a text of said errand service request.

14. The method of claim 13, wherein said receiving said errand service request includes selectively accepting or declining said text of said errand service request.

15. The method of claim 12, wherein said coordinating said errand service request with said at least one of said identified plurality of said proximate subcontractors includes selectively accepting or declining said errand service request by said at least one of said identified plurality of said proximate subcontractors.

16. The method of claim 15, wherein said coordinating said errand service request with said at least one of said identified plurality of said proximate subcontractors includes selectively accepting or declining said at least one of said identified plurality of said proximate subcontractors by said requesting user.

17. The method of claim 11, wherein identifying said plurality of proximate subcontractors based on said errand service and said errand service location includes subjecting said plurality of subcontractors to background checks.

18. The method of claim 11, wherein receiving said acceptance from at least one of said identified plurality of said proximate subcontractors to perform said errand service request includes information of said at least one of said identified plurality of said proximate subcontractors selected from a group consisting of a subcontractor name, a subcontractor telephone number, and a subcontractor password.

19. The method of claim 11 further comprising receiving comments and ratings from said requesting user about said at least one of said identified plurality of said proximate subcontractors upon completion of said errand service request.

20. The method of claim 19 further comprising receiving comments and ratings from said at least one of said identified plurality of said proximate subcontractors about said requesting user upon completion of said errand service request.
